(19) United States
(12) Patent Application Publication
(10) Pub. No.: US 2024/0348191 A1
(43) Pub. Date: Oct. 17, 2024

(54) KIT FOR BYPASSING A COMPRESSOR OR FAN

(71) Applicant: Regal Beloit America, Inc., Beloit, WI (US)

(72) Inventors: Jon Adams, Beloit, WI (US); Ludovic Chretien, Columbia City, IN (US); Sanjeev Shirahatti, Xenia, OH (US); Zachary Stauffer, Fort Wayne, IN (US); Michael R. Koller, Columbia City, IN (US)

(21) Appl. No.: 18/300,269

(22) Filed: Apr. 13, 2023

(51) Int. Cl. H02P 29/028; F24F 11/32; F24F 11/88

(52) U.S. Cl. CPC H02P 29/028; F24F 11/32; F24F 11/88

(57) ABSTRACT

An HVAC system including a compressor, a fan, and a bypass circuit for the compressor and/or fan are described herein. The bypass system includes a combination of circuits that work together to allow an electric machine to continue operation. The bypass circuit can be coupled to a failed drive to continue to operate the HVAC system if the drive or another part fails.

### TECHNICAL FIELD

The field of the disclosure relates generally to electric motors and, more specifically, to a method and apparatus for bypassing a failed compressor or fan of a drive control of an electric motor.

### BACKGROUND OF THE INVENTION

Many known electric motors are used with heating ventilation and cooling (HVAC) systems, such as, for example, an air conditioner or a heat pump, compressors, fans, or blowers. An electric motor can be used for a residential or commercial HVAC space, some of which employ a hybrid drive that switches between inverter power (e.g., variable speed operation) and line frequency power (e.g., fixed speed operation), increasing efficiency for a lower total system operating cost. A hybrid drive can run both the compressor and fan motors on outdoor air conditioner units, outdoor heat pumps, and compressor racks.

In an HVAC system, a failure of one or more parts may result in loss of an HVAC service such as heating or cooling. A part or electronics may fail or become damaged after a period of normal operation for a hybrid motor such one that cannot switch between line frequency and variable operation, such as a variable speed motor, a permanent magnet, an electronically commutated motor (ECM), or a permanent split capacitor (PSC) motor. At least some PSC motors, e.g., for compressors, employ two modes, or speeds, of operation including, e.g., variable speed operation at 15 Hz to 40 Hz and line frequency operation at 60 Hz. When a failure occurs, there are problems ranging from uneven temperature distribution to poor air flow. By defaulting to line-only operation, a system will continue to run even with a failed or damaged part or electronics. The complexity of wiring and controls may prevent intrinsic automatic bypass. Likewise, PSC motors for fans may be run without a capacitor and ECM driven fans cannot run if the main electronics are damaged. Thus, in some HVAC applications, a kit including a bypass circuit would be useful to circumvent the failed or damaged electronics or part in a compressor (or any three-phase loader) or fan to provide power and maintain the HVAC service until the failed or damaged part, or electric motor can be swapped, repaired, or replaced.

### BRIEF STATEMENT OF THE INVENTION

In one aspect, a heating ventilation and air conditioning (HVAC) system including a motor for power a load having a plurality of load electrical connections is provided. A voltage source is coupled to a drive for operating the load A circuit is coupled to the drive. The circuit is configured for automatic and manual bypass operation of the drive. The circuit is configured to bypass operation of the drive when the drive experiences failure, and the circuit operates the load instead of the drive. The circuit is configured for normal operation of the drive when the drive does not experience failure, and the drive continues to operate the load.

In another aspect, a heating ventilation and air conditioning (HVAC) system including a load having a plurality of load electrical connections is provided. A voltage source is coupled to a drive for operating the load. A circuit is coupled to the drive. The circuit is configured for automatic and manual bypass operation of the drive. The circuit is configured to bypass operation of the drive when the drive experiences failure, and the circuit operates the load instead of the drive. The circuit is configured for normal operation of the drive when the drive does not experience failure, and the drive continues to operate the load.

In yet another aspect, a bypass kit is provided. The bypass kit includes a contactor configured for coupling to a motor for powering a load, and for coupling to a drive for operating the load, the contactor includes inputs and outputs. The inputs are configured for coupling to a voltage source having a first line and a second line. The outputs are configured for coupling to an inverter of the motor. In an operable state, operation of the drive is bypassed when the drive experiences failure, and a circuit operates the load instead of the drive. In a disabled state, operation of the drive is normal when the drive does not experience failure, and the drive continues to operate the load.

### BRIEF DESCRIPTION OF THE DRAWINGS

FIG. 1 is a block diagram of an exemplary HVAC system;

FIG. 2 is a schematic diagram of one embodiment of a system for use in the HVAC system shown in FIG. 1;

FIG. 3 is a schematic diagram of another embodiment of a system for use in the HVAC system shown in FIG. 1;

FIG. 4 is a schematic diagram of one embodiment of a switch in harness or a cabinet bypass system for the compressor for use in the HVAC system shown in FIG. 1;

FIG. 5 is a schematic diagram of one embodiment of an installed manual bypass system for the compressor for use in the HVAC system shown in FIG. 1;

FIG. 6 is a schematic diagram of one embodiment of a two-wire PSC or integrated dry capacitor circuit for the fan for use in the HVAC system shown in FIG. 1;

FIGS. 7A and 7B are a schematic diagram of one embodiment of a system for an independent fan drive or modular drive, plus a selective bypass circuit for use in the HVAC system shown in FIG. 1;

FIG. 8 is a flow diagram of an exemplary method of bypassing a compressor or fan in HVAC system shown in FIG. 1.

### DETAILED DESCRIPTION

As used herein, an element or step recited in the singular and preceded with the word “a” or “an” should be understood as not excluding plural elements or steps, unless such exclusion is explicitly recited. Furthermore, references to “example implementation” or “one implementation” of the present disclosure are not intended to be interpreted as excluding the existence of additional implementations that also incorporate the recited features.

Permanent split capacitor (PSC) motors are fixed speed motors that are most efficient when operating at line frequency. Such PSC motors have uncontrolled acceleration during startup. Further, at low load conditions, such PSC motors operate at a higher power level than necessary. Alternatively, variable speed motor controllers exist that adapt motor speed to the load level, but are limited by power factor, electromagnetic interference, and electronic loss considerations. A hybrid motor system combines the low speed operating points, soft starting, and controlled acceleration benefits of a variable speed drive circuit (inverter power) with the line operable, increased power factor, and reduced electromagnetic interference (EMI) signature benefits of a fixed speed PSC motor to improve overall system operation.

Fans may draw air from the environment through a heat exchanger. An outdoor unit may draw environmental air through the heat exchanger using a fan and expel the air above the outdoor unit. An indoor unit includes a blower or fan that directs air through or across the indoor heat exchanger, where the air is cooled when the system is operating in air conditioning mode.

The drive for a PSC or a fan are parts of a HVAC system that may fail or become damaged during operation. To continue operation of an HVAC system when a part or electronics fail, a control system may be used to bypass a PSC or fan.

In one aspect, a control system for an electric motor in a compressor system is provided. The control system includes a processing system configured to control an inverter to supply on the drive power to the electric motor from the inverter. The processing system is configured to determine when to transition from supplying on the inverter drive power to supplying on the line power to the electric motor. The processing system is configured to engage a pressure equalization valve to at least partially reduce a pressure differential developed between a suction portion and a discharge portion of the compressor system. The processing system is configured to apply line frequency power to at least one winding of the electric motor. At least one winding remains with the electronics.

Embodiments of the present disclosure, it is realized herein, provide may provide HVAC systems that may utilize a PSC compressor in combination with a fan, drive and a controller. It is further realized herein that such an HVAC system may be operated in various configurations.

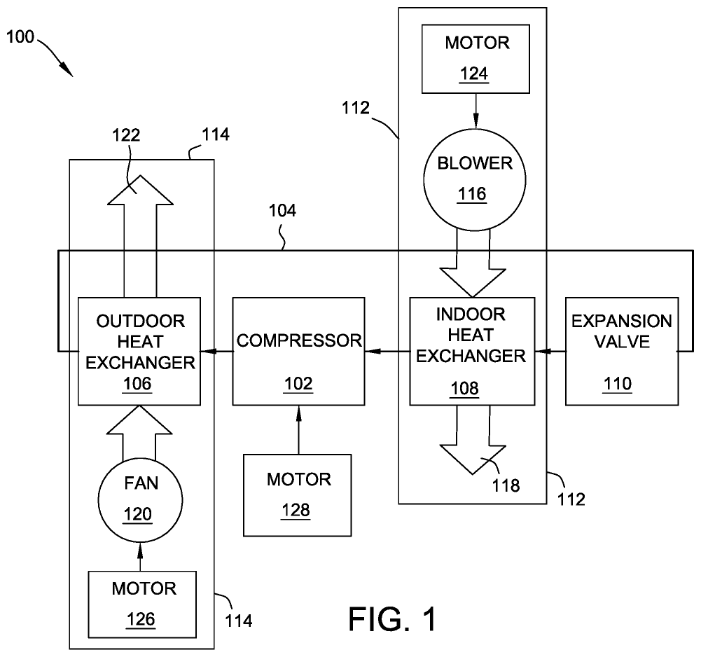

FIG. 1 is a block diagram of an exemplary HVAC system 100. HVAC system 100 includes a compressor 102 that compresses a refrigerant 104 to produce a pressure within HVAC system 100 and a resulting flow of refrigerant 104. Compressor 102 may have one or more levels of capacity. Generally, a compressor consumes more energy, i.e., electrical power, and is less efficient when operating at a high-capacity setting versus a low-capacity setting. Basic compressors are single capacity, and the variable speed/variable frequency operation allows modulation of mass flow rate in the HVAC system.

HVAC system 100 includes an outdoor heat exchanger 106, an indoor heat exchanger 108, and an expansion valve 110. Compressor 102 generates the flow of refrigerant 104 through each of outdoor heat exchanger 106, indoor heat exchanger 108, and expansion valve 110 to cool an interior space 112. Heat from interior space 112 is carried by refrigerant 104 and transferred to an exterior space 114. Interior space 112 and exterior space 114 combine to define a cooling load for HVAC system 100 as a function of a temperature set point for interior space 112 and an ambient temperature of exterior space 114. When operating as a heat pump, HVAC system 100 operates in reverse, carrying heat from exterior space 114 into interior space 112. Accordingly, where reference is made herein to cooling interior space 112, it should be understood that HVAC system 100 is also configured to heat interior space 112, and such descriptions should be considered non-limiting.

During operation, as cool low-pressure refrigerant 104 moves through indoor heat exchanger 108, a blower 116 generates an interior airflow 118 through indoor heat exchanger 108. Interior airflow 118 carries warm air from interior space 112 through indoor heat exchanger 108, thereby cooling interior airflow 118 and heating refrigerant 104. Low-pressure refrigerant 104 flows from indoor heat exchanger 108 into compressor 102 and is compressed, raising the temperature and pressure of refrigerant 104 before it flows into outdoor heat exchanger 106. HVAC system 100 includes a fan 120 that generates an exterior airflow 122 through outdoor heat exchanger 106. As hot high-pressure refrigerant 104 moves through outdoor heat exchanger 106, exterior airflow 122 carriers ambient air from exterior space 114 through outdoor heat exchanger 106, thereby cooling refrigerant 104 and heating exterior airflow 122. High-pressure refrigerant 104 flows from outdoor heat exchanger 106 into expansion valve 110, where refrigerant 104 is decompressed and cooled before flowing back into indoor heat exchanger 108.

HVAC system 100 also includes a PSC motor 124 coupled to blower 116 and configured to turn blower 116 at a variable speed/variable frequency. The speed at which blower 116 turns determines the volume of air in interior airflow 118 that moves through indoor heat exchanger 108. Moreover, the efficiency with which energy is transferred from the warm interior airflow 118 to the cool low-pressure refrigerant 104 flowing through indoor heat exchanger 108 is a function of the volume of air and the speed at which blower 116 turns. Further, the speed of blower 116 that is necessary to achieve efficient energy transfer may be reduced as the cooling load decreases. Although electric motor 124 is illustrated as a PSC motor, it is recognized that other known motors (such as permanent magnet or electronically commutated motors (ECMs)) could be used.

HVAC system 100 includes a PSC motor 126 coupled to fan 120 and configured to turn fan 120 at a variable speed/variable frequency. The speed at which fan 120 turns determines the volume of air in exterior airflow 122 that moves through outdoor heat exchanger 108. Moreover, the efficiency with which energy is transferred from the warm high-pressure refrigerant 104 flowing through outdoor heat exchanger 106 to exterior airflow 122 is a function of the volume of air and the speed at which fan 120 turns. Further, the speed of fan 120 that is necessary to achieve efficient energy transfer may be reduced as the cooling load decreases.

HVAC system 100 includes an electric motor 128 for driving compressor 102, and the motor can include an electronic drive (e.g., hybrid) coupled to compressor 102. A hybrid drive is a combination of a line frequency power circuit and an inverter drive, or variable frequency drive. Motor 128 provides power to compressor 102 and the electronic drive for the electric machine regulates an output voltage and frequency to control the speed at which compressor 102 operates, thereby affecting the overall cooling capacity of compressor 102. More specifically, when operating compressor 102 at AC line voltage, the drive of the motor 128 is bypassed, thereby eliminating the operating losses introduced by the electronics of the drive.

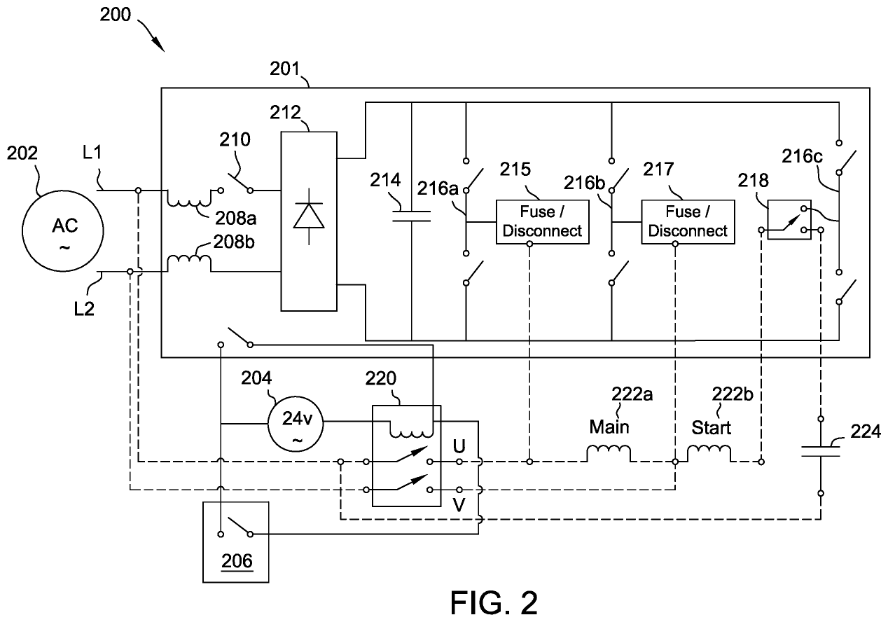

FIG. 2 is a schematic diagram of an exemplary embodiment of a bypass system 200 for the compressor 102 for use in the HVAC system 100 shown in FIG. 1. System 200 includes variable speed/variable frequency controller/drive or inverter drive 201 for an electric motor, such as a PSC motor, an AC voltage source 202, two fuse disconnects 215 and 217, a capacitor 224, and a low voltage 24-volt AC source 204 (which includes a switch) connected to a variable-speed outdoor unit (VSODU) 206 (which includes a switch).

The inverter drive 201 for driving an electric motor coupled to a compressor, for example, includes an electric motor having a main winding 222a, a start winding 222b. The inverter drive 201 includes a switch 210, a rectifier 212, a capacitor 214, an inverter leg 216a connected to fuse disconnect 215, an inverter leg 216b connected to fuse disconnect 217, and a relay 218 for an inverter leg 216c. The electric motor is the original motor in the HVAC system 100. A bypass kit for a failed drive can be provided by a combination of elements including VSODU 206, disconnects 215 and 217, and contactor 220, which work together to enable bypass and continued operation of the HVAC system.

During normal drive frequency operation, line frequency current, such as 50 Hertz or 60 Hertz, for example, is supplied on a first line, or L1, through the rectifier 212 and electrolytic capacitor 214. Then the inverter leg 216c provides power to the start winding 222b and to the main winding 222a. Line operation occurs when contactor 220 closes. A second line, or L2, provides a return, or neutral, for the line frequency current and includes an EMI filter 208b. Inverter drive 201 includes an EMI filter 208a and switch 210 for connecting and disconnecting the drive 201. In certain embodiments, switch 210 may be coupled to either L1 or L2. The terms line frequency current, voltage, and/or power are used interchangeably herein to refer to direct electrical communication with AC voltage source 202. In other embodiments, switch 210 can be omitted.

Inverter drive 201 includes an inverter leg 216c that is enabled to drive the electric motor connected to main winding 222a and 222b with variable frequency power under low load, or at least less than full load, conditions. Inverter leg 216c is supplied line frequency power on L1 and L2. Inverter leg 216c enables variable speed/variable frequency operation of the electric motor by regulating amplitude, phase, and frequency of alternating current (AC) voltages on output terminals thereof, which are coupled to main winding 222a and start winding 222b. When operating the electric motor using inverter leg 216c, relay 218 connects the start winding to the inverter and inverter leg 216c is enabled via any suitable control means. To transition to line frequency power, inverter leg 216c is disabled, relay 218 connects the run capacitor 224 to the start winding, and the contactor 220 is commutated to couple L1 and L2 directly to the electric motor. Relay 218 may be embodied as a mechanical/electromechanical contactor, an electronic switch, and/or or a solid-state switch.

In the illustrated embodiment, inverter leg 216c includes a capacitor 214 and a plurality of switches arranged in three parallel sets of switches also referred to as phases of inverter leg 216c (e.g., first set of switches may be referred to as a first phase, second set of switches may be referred to as a second phase, and third set of switches may be referred to as a third phase). Winding 208a is coupled to first phase at a first node and to a second phase at a second node. Under the first mode of operation of inverter drive 201, start winding 208b is coupled to a third phase at a third node and is coupled to second phase through a second node.

Rectifier 212 rectifies power from AC source 202, capacitor 214 functions as a storage element for the rectified power from rectifier 212, and the sets of switches (phases) operate to regulate current provided to main winding 222a, and start winding 222b in the different modes of operation (inverter power or line power). To transition between modes of operation, inverter switches stop regulating current (i.e., open) and contactor 220 closes, and the load is shifted from the inverter to line frequency voltage.

Switches may be controlled (e.g., closed, opened, commutated) by any suitable control means, such as, for example, a microcontroller, a field programmable gate array (FPGA), a digital signal processing (DSP) device, a remote system controller, a local system controller, and the like. Switches may be controlled to enable switching between the first and second modes of operation within about 1 line cycle or less.

Although the electric motor is illustrated as a PSC motor, it is recognized that other known motors (such as electronically commutated motors (ECMs)) also have integrated windings (e.g., between windings of a three-phase ECM). The electric motor may be an induction motor, such as a PSC motor, or a permanent magnet motor, such as an ECM. Moreover, the electric motor may drive a compressor, or may drive any other fluid-moving apparatus, such as a fan, blower, impeller, pump, and the like.

As shown in FIG. 2, inverter drive 201 includes six wired drive load connections using a harness or other means to bypass the wirings on the inverter drive 201. The load connections include a motor connector, and an input power connector and power bypass adaptor are provided for the AC voltage source 202. Bypass for a failed part or electronics such as an inverter drive 201 for a compressor is provided by the bypass circuit connected to the AC voltage source 202, and the combination of switches (e.g., contactor 220), fuse disconnects 215 and 217, and controllers (e.g., VSODU 206) that bypasses the inverter drive 201 to enable and to continue operation of the HVAC system.

A command for automatic bypass is provided either a standalone electronic circuit, a system controller or a thermostat. A standalone electronic circuit would be supervisory electronics external to the thermostat or system controller VSODU that would take the action to automatically enable the bypass feature.

A first connection point includes the U terminal on the output of the contactor 220, the main winding 222a and the inverter leg 216a. A second connection point includes the V terminal on the output of the contactor 220, the main winding 222a, the start winding 222b, and the inverter leg 216b. A third connection point includes the start winding 222b and a connection of the relay 218. A fourth connection point includes the capacitor 224 and a connection of the relay 218. One input of the contactor 220 is connected to the line L2. The other input of the contactor 220 is connected to the line L1

Bypass circuit enables coupling to L1 and L2 to enable and continue operation of the PSC motor. The combination of switches (e.g., contactor 220), fuse disconnects 215 and 217, and controllers (e.g., VSODU 206) bypasses the inverter drive 201. When operating the electric motor using the bypass circuit, contactor 220 is operable. Contactor 220 is a two-pole mechanical contactor that is commutated by the 24-volt AC source 204 energizing a coil. The 24-volt AC source 204 is connected between a switch on the inverter drive 201 and a switch on the VSODU 206 (using a power bypass adaptor). One pole of the contactor 220 is wired to L1, and the other pole is wired to L2. One pole of contactor 220 is also connected to fuse disconnect 215 on inverter leg 216a on one side of main winding 222a, while one pole of contactor 220 is connected to a fuse disconnect 217 on inverter leg 216b on the other side of main winding 222a. When operating the electric motor using the bypass circuit, contactor 220 is operable. Run capacitor 224 is coupled to one connection of relay 218 and contactor 220. Start winding 222b is coupled to another connection of relay 218. When operating the electric motor under normal on-the-line conditions, contactor 220 is closed.

Relays or fuse disconnects are added on U and V phase inverter output for the compressor to automatically disconnect the damaged inverter drive 201. Alternate or dual control (i.e., a system controller) of the relay coil of the 24-volt AC voltage source 204 is provided via thermostat Y line or the variable-speed outdoor unit (VSODU) 206.

In FIG. 2 an electric motor is configured to drive the motor to generate an airflow. The electric motor is a permanent split capacitor (PSC) motor for a compressor and includes a hybrid inverter drive coupled to and configured to operate the compressor at an inverter power or with line frequency power. A control system, or motor controller, configured to operate the PSC motor and compressor includes a processor coupled to an input, i.e., the AC line voltage source. Bypass for a failed part or electronics such as an inverter drive for a compressor is provided by a bypass kit connected to an AC source. Input power topology is used for front end bypass. The bypass kit includes a PSC motor for replacing a failed inverter for an electronically commutated motor (ECM) if the initial unit does not have a PSC fan motor. The bypass kit also includes a power bypass adaptor, a fan adaptor, a high pressure switch (HPS) short link, a wire loop, and a capacitor.

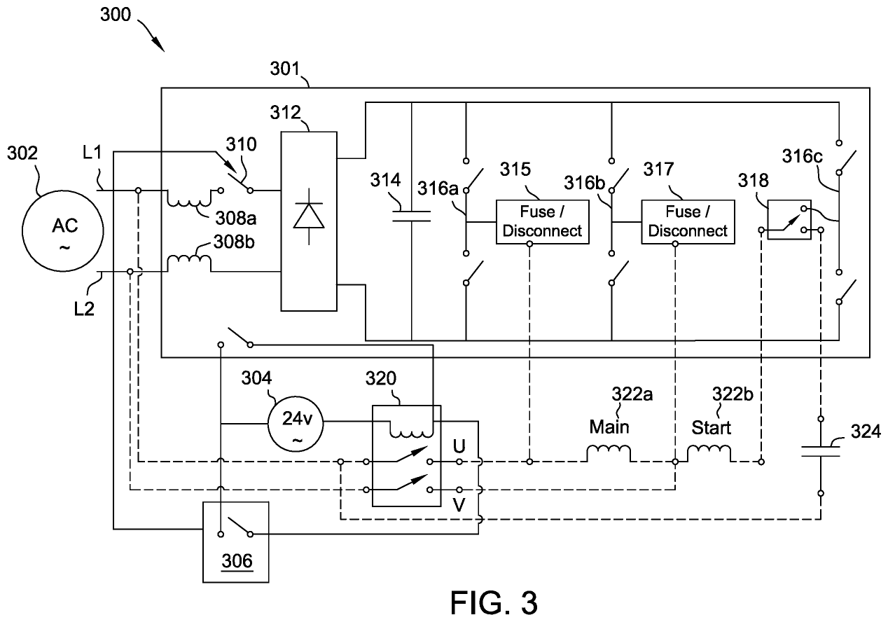

FIG. 3 is a schematic diagram of an exemplary embodiment of a common AC source bypass system 300 for the compressor 102 for use in the HVAC system 100 shown in FIG. 1. System 300 includes a variable speed/variable frequency controller/drive or inverter drive 301 for an electric motor, such as a PSC motor, an AC voltage source 302, two fuse disconnects 315 and 317, and a low-voltage 24-volt AC source 304 (which includes a switch) connected to a variable-speed outdoor unit (VSODU) 306 (which includes a switch).

The inverter drive 301 for driving an electric motor coupled to a compressor, for example, includes an electric motor having a main winding 322a, and a start winding 322b. The inverter drive 301 includes a switch 310, a rectifier 312, a capacitor 314, an inverter leg 316a connected to fuse disconnect 315, an inverter leg 316b connected to fuse disconnect 317, and a relay 318 for an inverter leg 316c. Common AC source bypass elements include a contactor 320, a main winding 322a, a start winding 322b, and a run capacitor 324. The electric motor is the original motor in the HVAC system 100. A bypass kit for a failed inverter drive 301 can be provided a combination of elements including VSODU 306, disconnects 315 and 317, and contactor 320, that work together to enable bypass and continued operation of the HVAC system. A common AC source 302 is used with bypass of the inverter drive 301. The normal drive frequency operation in FIG. 3 is similar to the normal drive frequency operation in FIG. 2. In addition, features of the inverter drive 301 and bypass kit in FIG. 3 are similar to the features of the inverter drive 201 and bypass kit in FIG. 2.

As shown in FIG. 3, inverter drive 301 includes six wired load connections to using a harness or other means to bypass the wirings on the inverter drive 301. The load connections include a motor connector, and an input power connector and power bypass adaptor are provided for the AC voltage source 302. Bypass for a failed part or electronics such as an inverter drive 301 for a compressor is provided by the bypass circuit connected to the AC voltage source 302, and the combination of switches (e.g., contactor 320), fuse disconnects 315 and 317, and controllers (e.g., VSODU 306) that bypasses the inverter drive 301 to enable and continue operation of the HVAC system.

A command for automatic bypass is provided either a standalone electronic circuit, a system controller or a thermostat. A standalone electronic circuit would be supervisory electronics external to the thermostat or system controller VSODU that would take the action to automatically enable the bypass feature.

The connection points on the variable speed/variable frequency controller/drive or inverter drive 301 in FIG. 3 are similar to the connection points on the inverter drive 201 in FIG. 2.

Similar to the bypass circuit in FIG. 2, bypass circuit in FIG. 3 includes a contactor 320 for connecting and disconnecting line L1 and line L2 to the PSC motor. A second line, or L2, provides a return, or neutral, for the line frequency current and includes an EMI filter 308b. Inverter drive 301 includes an EMI filter 308a and switch 310 for connecting and disconnecting the drive 302. The contactor 320 is energized by the 24-volt AC source 304. The 24-volt AC source 304 is connected between a switch on the inverter drive 301 and a switch on the VSODU 306 (using a power bypass adaptor).

Relays or fuse disconnects are added on U and V phase inverter output for the compressor to automatically disconnect the damaged inverter drive 301. Alternate or dual control (i.e., a system controller) of the relay coil (inrush relay/switch) of the 24-volt AC voltage source 304 is provided via thermostat Y line or the variable-speed outdoor unit (VSODU) 306.

In FIG. 3, similar to FIG. 2, bypass for a failed part or electronics such as an inverter drive for a compressor is provided by a bypass kit connected to an AC source. An inverter drive is used with a common AC source at the front end. There is no need to remove the connector.

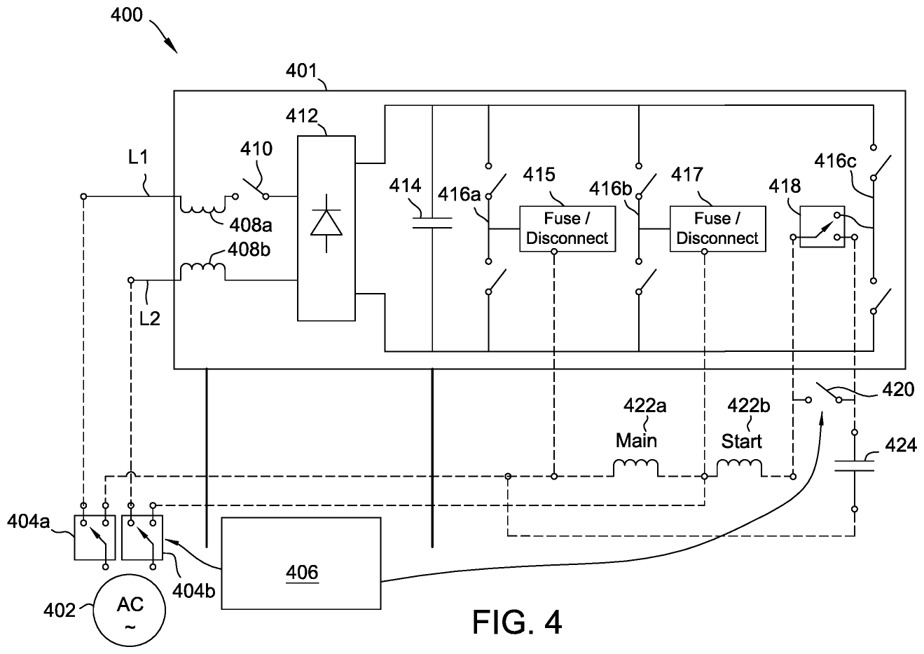

FIG. 4 is a schematic diagram of another exemplary embodiment of a switch in harness or a cabinet bypass system 400 for the compressor 102 for use in the HVAC system 100 shown in FIG. 1. System 400 includes variable speed/variable frequency controller/drive or inverter drive 401 for an electric motor, such as a PSC motor, an AC voltage source 402, two fuse disconnects 415 and 417, and a variable-speed outdoor unit (VSODU) controller 406.

The inverter drive 401 for driving a compressor, for example, includes an electric motor having a main winding 422a, and a start winding 422b. The inverter drive 401 includes a switch 410, a rectifier 412, a capacitor 414, an inverter leg 416a connected to a fuse disconnect 415, an inverter leg 416b connected to a fuse disconnect 417, and a relay 418 for an inverter leg 416c. Independent control/system control for switching for a bypass system includes a contactor 404a, a contactor 404b, a switch 420 in a harness (external controller) or integrated with VSODU 406, and a capacitor 424. The electric motor is the original motor in the HVAC system 100 including a main winding 422a and a start winding 422b. A bypass kit for a failed inverter drive 401 can be provided by a combination of elements including VSODU 406, disconnects 415 and 417, contactor 404a, and contactor 404b, that work together to enable bypass and continued operation of the HVAC system.

The switch 420 in a harness or integrated to VSODU 406 is used for bypassing a failed switch 418 of inverter drive 401. The normal drive frequency operation in FIG. 4 is similar to the normal drive frequency operation in FIG. 2. In addition, features of the inverter drive 401 and bypass kit in FIG. 4 are similar to the features of the inverter drive 201 and bypass kit in FIG. 2.

As shown in FIG. 4, inverter drive 401 includes six wired load connections using a harness or other means to bypass a drive using a switch 420 in a harness or integrated to VSODU 406 to bypass the wirings on the inverter drive 401. The load connections include a motor connector, and an input power connector and power bypass adaptor is provided for the AC voltage source 402. Bypass for a failed part or electronics such as an inverter drive 401 for a compressor is provided by the bypass circuit connecting the motor to AC voltage source 402, and comprising the combination of switches (e.g., contactors 404a and 404b), fuse disconnects 415 and 417, and controllers (e.g., VSODU 406) that bypasses the inverter drive 401 to enable and continue operation of the HVAC system.

A command for automatic bypass is provided either a standalone electronic circuit, a system controller or a thermostat. A standalone electronic circuit would be supervisory electronics external to the thermostat or system controller VSODU that would take the action to automatically enable the bypass feature.

AC voltage source 402 is connected to both inputs of contactors 404a and 404b. Line L1 is connected to the output of contactor 404a and line L2 is connected to output of contactor 404b. These are the first and second connection points. A second line, or L2, provides a return, or neutral, for the line frequency current and includes an EMI filter 408b. Inverter drive 401 includes an EMI filter 408a and switch 410 for connecting and disconnecting the drive 401. A third connection point includes the contactor 404a, the main winding 422a, and the inverter leg 416a. A fourth connection point includes the contactor 404b, the start winding 422b and the inverter leg 416b. A fifth connection point includes the start winding 422b and the relay 418. A sixth connection point is between the switch 420, the capacitor 424 and the start winding 422b.

Bypass circuit enables coupling to L1 and L2 to enable and continue operation of the PSC motor. The combination of switches (e.g., switch 410), fuse disconnects 415 and 417, and controllers (e.g., VSODU 406 and contactors 404a and 404b) bypasses the inverter drive 401. When operating the electric motor using the bypass circuit, contactors 404a and 404b are operable. The contactor 404a and 404b are energized by AC source 402. One pole of the contactor 404a is wired to L1, and the other pole is wired to L2. One pole of contactor 404a is also connected to a fuse disconnect 415 on inverter leg 416a on one side of main winding 422a, while one pole of contactor 404b is connected to a fuse disconnect 417 on inverter leg 416b on the other side of main winding 422a. When operating the electric motor using the bypass circuit, contactors 404a and 404b are operable. Run capacitor 424 is coupled to one connection of relay 418 and start winding 422b is coupled to another connection of relay 418. Run capacitor 424 is also connected to switch 420. When operating the electric motor under normal conditions, contactors 404a and 404b are providing power to the drive.

An independent controller or system controller is used as a switching network controller for the system. The switching network selectively powers the electric motor including windings 422a and 422b. This alternate circuit topology includes one additional switch.

In FIG. 4, a switch is provided in a harness or integrated in a circuit (i.e., an adapter) is used for bypass for a failed part or electronics such as an inverter drive for a compressor. Independent controller or system controller is used for the switching network controller.

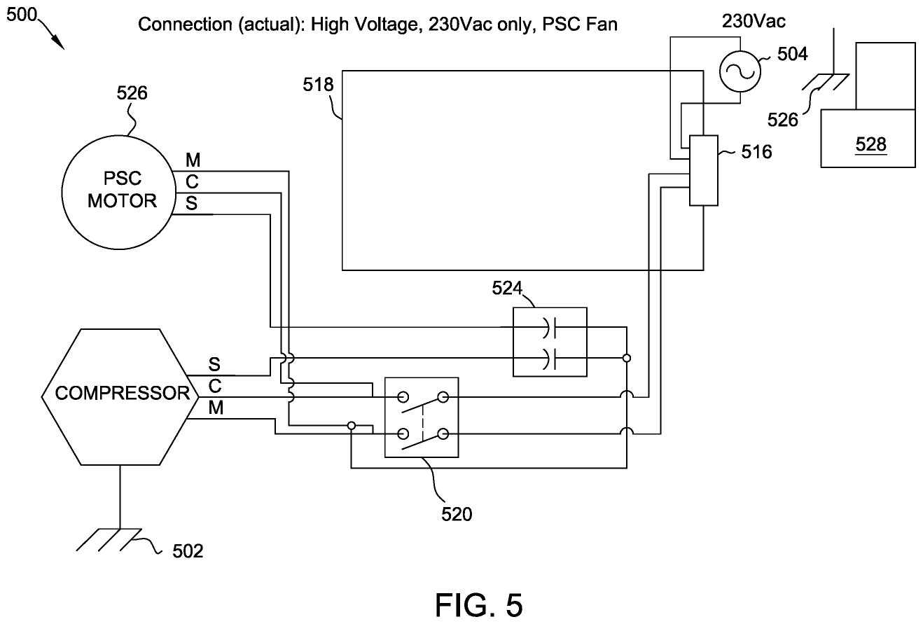

FIG. 5 is a schematic diagram of an exemplary embodiment of an installed manual bypass system 500 for the compressor 102 for use in the HVAC system 100 shown in FIG. 1. System 500 includes variable speed/variable frequency controller/drive or inverter drive 518 for an electric motor, such as a PSC motor 526 for driving a fan, a 230-volt AC voltage source 504 connected to drive 516, a compressor 502. A bypass kit for failed drive 518 can be provided by a combination of elements including an input connector bypass 516, and a run capacitor 524. A main relay 520 (with connections) is part of the default HVAC system.

Before installing a bypass kit for a failed hybrid drive 518, the following steps are required. First, equipment should be checked to verify the correct bypass kit for the electric motor. Next, AC source power 504 and drive are manually disconnected from an HVAC unit being serviced. Next, connectors on the drive board are disconnected including the fan motor, compressor motor, input power, communication, relay coil and high-pressure (HP) switch. Then, the board is bypassed and a run capacitor is rewired as well as control of contactor to VSODU or an external controller. A brushless DC (BLDC) fan motor can be replaced with the PSC motor 526.

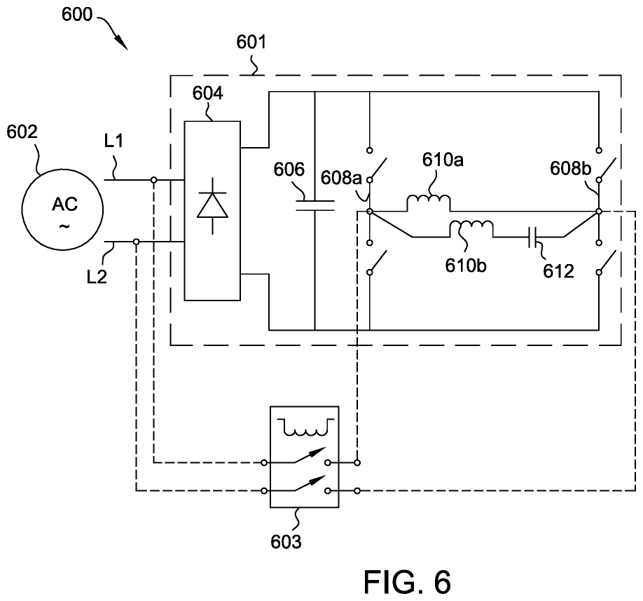

FIG. 6 is a schematic diagram of an exemplary embodiment of a two-wire PSC or integrated dry capacitor circuit system 600 for the fan 120 for use in the HVAC system 100 shown in FIG. 1. System 600 includes fan drive 601 for a fan, an AC voltage source 602, and a kit including a two-wire PSC or integrated dry capacitor as a bypass contactor 603. The fan drive 601 for driving a fan includes an electric motor having a main winding 610a and a start winding 610b. The fan drive 601 includes a rectifier 604, an electrolytics capacitor 606, inverter legs 608a and 608b, and a dry capacitor 612.

A bypass kit for a failed fan drive can be provided by a combination of elements including a contactor 603 having a coil winding (powered by the voltage source 602 using a power bypass adaptor).

During normal drive operation, line frequency current, is supplied on a first line, or L1, through the rectifier 704 and electrolytics capacitor 606, pulse width modulated by the inverter legs 608a and 608b to the start winding 610b, and to the main winding 610a. A second line, or L2, provides a return, or neutral, for the drive frequency current.

Fan drive 601 includes inverter legs 608a and 608b that is enabled to drive the electric motor connected to main winding 610a and start winding 610b. Inverter legs 608a and 608b is supplied line frequency power on L1 and L2.

In the illustrated embodiment, fan drive 601 includes a capacitor 612 and two switches arranged in two parallel sets of switches also referred to as phases of inverter legs 608a and 608b (e.g., first set of switches may be referred to as a first phase, and the second set of switches may be referred to as a second phase).

Rectifier 604 rectifies power from AC source 602, capacitor 606 functions as a storage element for the rectified power from rectifier 604, and the sets of switches (phases) operate to regulate current provided to main winding 610a and start winding 610b in the different modes of operation (inverter power or line power). To transition between modes of operation, inverter switches stop regulating current (i.e., open) and contactor 603 closes, and the load is shifted from the inverter to line frequency voltage.

Switches may be controlled (e.g., closed, opened, commutated) by any suitable control means, such as, for example, a microcontroller, a field programmable gate array (FPGA), a digital signal processing (DSP) device, a remote system controller, a local system controller, and the like. Switches may be controlled to enable switching between the first and second modes of operation within about 1 line cycle or less.

Although the electric motor is illustrated as a fan, it is recognized that other known motors also have integrated windings such as a blower, impeller, and the like.

As shown in FIG. 6, fan drive 601 for a fan includes four wired load/fan connections to bypass contactor 60 using a harness or other means to bypass the wirings on the fan drive 601. The fan connections include a motor connector, and an input power connector and power bypass adaptor are provided for the AC voltage source 602.

Manual override for manual bypass may include a several connection points. A first connection point and a second connection point include the contactor 604 and the fan drive 601 using connections at L1 and L2 of the AC voltage source 602. A third connection point includes one output pole of the contactor 604 and the inverter leg 608a. A fourth connection point includes the other output pole of the contactor 603 and the inverter leg 608b.

In FIG. 6, the capacitor may be located with the PSC, or packaged with the drive.

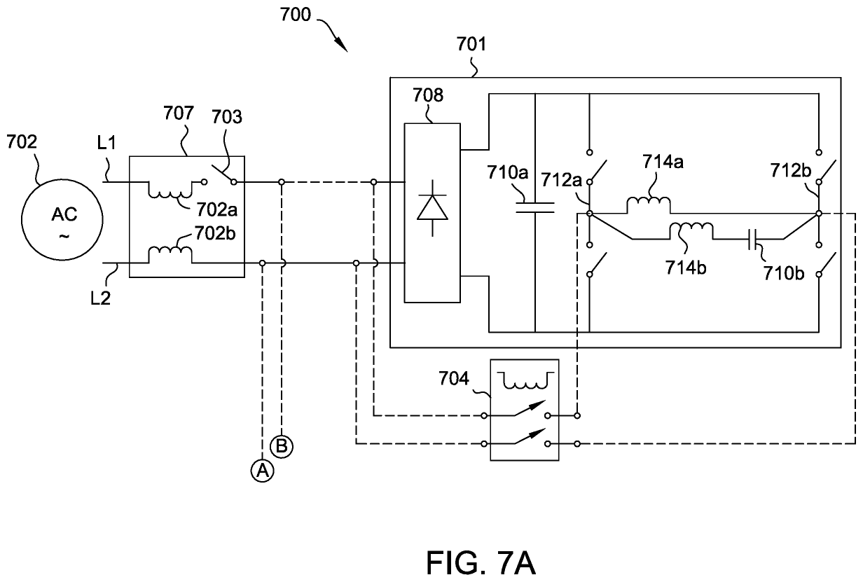

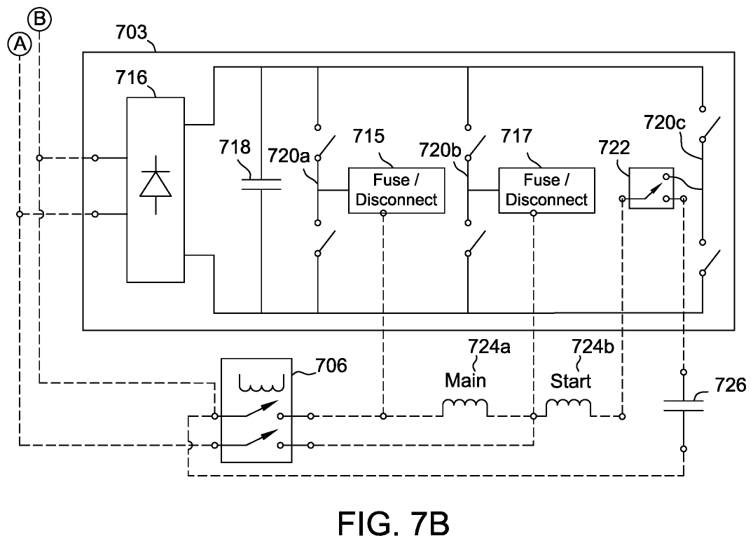

FIGS. 7A and 7B are a schematic diagram of one embodiment of a system 700 for an independent fan drive or modular fan and an inverter drive for a compressor, and selective bypass circuitry. The system 700 includes independent fan drive 701 for a fan, an inverter drive 703 for a modular compressor, a front end electromagnetic interference (EMI) circuit 707, a bypass contactor 704 for the fan drive 701, a contactor 706 for the inverter drive 703, and an AC voltage source 702 for line L1 and line L2 Front end 707 includes contactor 703 and EMI filter comprising 2 windings 702a and 702b.

The fan drive 701 in FIGS. 7A and 7B is similar to the fan drive 601 in FIG. 6. The fan drive includes a rectifier 708, a capacitor 710a, an inverter leg 712a, a main winding 714a, a start winding 714b, an inverter leg 712b, and a capacitor 710b.

The inverter drive 703 in FIGS. 7A and 7B is similar to the inverter drive 201 in FIG. 2. The inverter drive 703 includes a rectifier 716, a capacitor 718, an inverter leg 720a, an inverter leg 720b, a relay 722 (with connections), and an inverter leg 720c.

As shown in FIGS. 7A and 7B, fan drive 701 includes four wired fan/load connections to contactor 704, while inverter drive 703 includes six wired load connections to contactor 706. The connections are made using a harness or other means to bypass the wirings on the drives 701 and 703. The load connections include a motor connector, the fan connections include a motor connection, and an input power connector and power bypass adaptor are provided for the AC voltage source 702. The contactors 704 and 706 are energized by the AC voltage source 702. Bypass for a failed part or electronics such as a fan drive 701 or an inverter drive 703 is provided by the contactors 704 and 706 connected to the AC voltage source 702 and the front-end electromagnetic interference (EMI) circuit 707 to continue operation of the HVAC system.

Selective bypass for a failed part or electronics such as an inverter drive for a fan, a PSC motor for a compressor, or both, is provided by the kit for a bypass. Bypass for one or more failed drives can be provided by a combination of elements including contactor 704 connected to the fan drive 701, and contactor 706 connected to the inverter drive 703, switches (e.g., switch 703), and fuse disconnects 715 and 717. These elements enable and continue operation of the HVAC system.

Bypass contactor 704 is connected to fan drive 701 at four connection points using a harness or other means to bypass the drive wiring. A first connection point and a second connection point include the front end of the inverter drive 701. The first connection point and the second connection point include the contactor 704 and the fan drive 701 at L1 and L2 of the AC voltage source 702. A third connection point includes one output pole of the contactor 704 and inverter leg 712a. A fourth connection point includes one output pole of the contactor 794 and inverter leg 712b.

Contactor 706 is connected to the inverter drive 703 at six connection points using a harness or other means to bypass the drive wiring. A first connection point and a second connection point include the front end of the inverter drive 703. The first connection point and the second connection point include the contactor 706 and the drive circuit 703 at L1 and L2 of the AC voltage source 702. A third connection point includes one output pole of the contactor 706, a fuse disconnect 715 connected to the inverter leg 720a, and one end of the main winding 724a. A fourth connection point includes the other output pole of the contactor 706, a fuse disconnect 717 connector to the inverter leg 720b, a connection point between the other end of the main winding 724a and one end of the start winding 724b. A fifth connection point includes the other end of the start winding 724b and a connection of the relay 722 connected to the inverter leg 720c. A sixth connection point includes an input pole of the contactor 706 to capacitor 726.

In FIGS. 7A and 7B, an independent fan drive 701, an inverter drive 703, and selective bypass are used for a failed part or electronics such as a drive for a fan or a compressor. A separate EMI circuit 707 is used at the front end along with transient protection. An inverter drive 703 with a dedicated rectifier 716, electrolytic capacitors, and low-voltage power supply are used. A fan drive 701 with a dedicated rectifier 708, electrolytics, and low voltage power supply are used. Independent bypass contactors 704 and 706 are provided for the fan drive 701 and the compressor drive circuit 703 Bypass control can be any of the previous methods presented for a compressor or a fan.

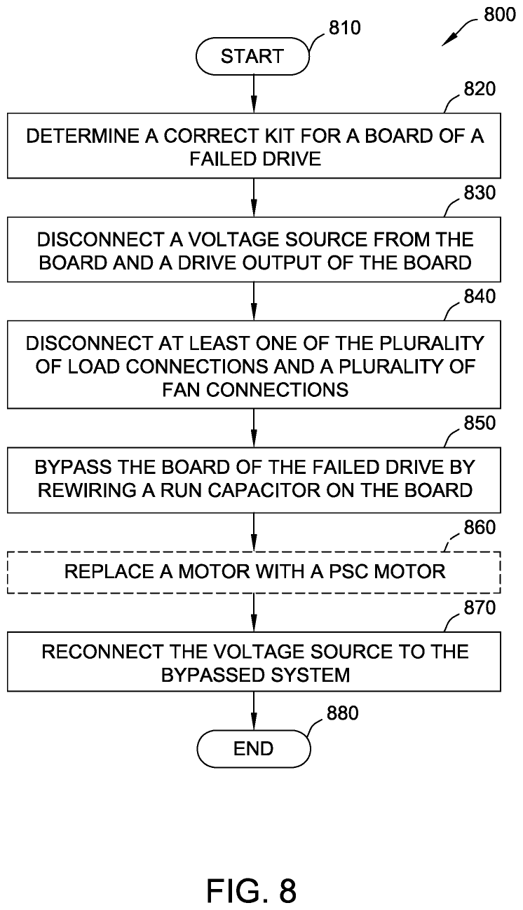

FIG. 8 is a flow diagram of an exemplary method 800 of bypassing a compressor or fan in the HVAC system shown in FIGS. 1 and 5. Method 800 for installing a manual bypass circuit used for a failed part or electronics such as an inverter drive for a compressor or fan is provided.

Method 800 begins at a start step 810. A technician determines a correct kit for a board for a failed drive 516 at a determination step 820.

At disconnect step 830, AC voltage source power 504 and drive output 516 are manually disconnected from the board being serviced.

Next, at disconnect step 840, the connections for either of both of the motor 128 of the compressor 102 and the motor 126 of fan 120 are manually disconnected. Then, the board is rewired with a kit at bypass step 850, and a run capacitor 524 is rewired as well. Control of contactor to VSODU or an external controller may be rewired. A second motor may be for a pump rather than a fan

In an optional step, as needed, depending on the type of fan or motor, a motor 126 is replaced at step 860. The motor can be for a fan or a PSC motor when the drive is not a dual drive.

At step 870, the voltage source 504 is reconnected to the bypassed system.

Method 800 terminates at end step 880.

Without a bypass kit for a compressor or fan, it would be challenging to bypass a failed drive because all the connections are located on the drive. This bypass kit provides harnessing and also provides a PSC outdoor motor that is not available in the failed HVAC unit. Also, without a bypass kit, the likelihood of damaging a HVAC unit increases if attempts are made to make harness connections between various parts of the system. Rather than being external to the failed inverter drive, the bypass kit can be built into the board of an inverter drive and a switch or other component can be used to automatically bypass the drive. Then, the remaining step would be to swap out the motor in case an ECM was originally in the system.

In addition, a bypass kit for a failed or damaged inverter drive is applicable to other products besides AC and heat pumps. It may be applicable for some modulating motors currently used, EC motors, as well as a PSC motor. An example of an application includes water heaters or any other system that uses a compressor.

HVAC systems described herein provide hybrid system that continues to operate if an inverter drive fails, which is not the case with a standard fully variable system. More specifically, embodiments of the HVAC systems described herein may utilize cooling with simple changes to the connections. It is further realized herein that such an HVAC system may be operated in various configurations including all the connections located on the inverter board or including an external wire harness. More specifically, as realized herein, in certain embodiments, operation of the bypass circuit can occur automatically or manually with a wire harness. It is further realized herein that a bypass circuit may be embedded into an inverter board.

It is further realized herein that the bypass kit has the ability to continue to operate a variable speed/variable frequency controller/drive or inverter drive unit with failed electronics by bypassing the electronics without changing the electronics.

The methods and systems described herein may be implemented using computer programming or engineering techniques including computer software, firmware, hardware or any combination or subset thereof, wherein the technical effect may include at least one of: (a) combining a compressor with a variable speed drive, e.g., a variable-voltage/variable-frequency drive (or inverter drive) and a fan with an inverter drive; (b) reducing losses by bypassing a failed inverter drive; (c) reducing costs associated with failed HVAC systems by continuing to operate until a failed or damaged part or electronics, or motor can be replaced.

Some embodiments involve the use of one or more electronic or computing devices. Such devices typically include a processor, processing device, or controller, such as a general purpose central processing unit (CPU), a graphics processing unit (GPU), a microcontroller, a reduced instruction set computer (RISC) processor, an application specific integrated circuit (ASIC), a programmable logic circuit (PLC), a field programmable gate array (FPGA), a digital signal processing (DSP) device, and/or any other circuit or processing device capable of executing the functions described herein. The methods described herein may be encoded as executable instructions embodied in a computer readable medium, including, without limitation, a storage device and/or a memory device. Such instructions, when executed by a processing device, cause the processing device to perform at least a portion of the methods described herein. The above examples are exemplary only, and thus are not intended to limit in any way the definition and/or meaning of the terms processor, processing device, and controller.

In the embodiments described herein, memory may include, but is not limited to, a computer-readable medium, such as a random access memory (RAM), and a computer-readable non-volatile medium, such as flash memory. Alternatively, a floppy disk, a compact disc-read only memory (CD-ROM), a magneto-optical disk (MOD), and/or a digital versatile disc (DVD) may also be used. Also, in the embodiments described herein, additional input channels may be, but are not limited to, computer peripherals associated with an operator interface such as a mouse and a keyboard. Alternatively, other computer peripherals may also be used that may include, for example, but not be limited to, a scanner. Furthermore, in the exemplary embodiment, additional output channels may include, but not be limited to, an operator interface monitor.

As used herein, the terms “software” and “firmware” are interchangeable and include any computer program stored in memory for execution by a processor, including RAM memory, ROM memory, EPROM memory, EEPROM memory, and non-volatile RAM (NVRAM) memory. The above memory types are examples only, and are thus not limiting as to the types of memory usable for storage of a computer program.

The systems and methods described herein are not limited to the specific embodiments described herein, but rather, components of the systems and/or steps of the methods may be utilized independently and separately from other components and/or steps described herein.

This written description uses examples to provide details on the disclosure, including the best mode, and also to enable any person skilled in the art to practice the disclosure, including making and using any devices or systems and performing any incorporated methods. The patentable scope of the disclosure is defined by the claims and may include other examples that occur to those skilled in the art. Such other examples are intended to be within the scope of the claims if they have structural elements that do not differ from the literal language of the claims, or if they include equivalent structural elements with insubstantial differences from the literal language of the claims.

What is claimed is:

1. A heating ventilation and air conditioning (HVAC) system, comprising:
a motor for powering a load;
a voltage source having a first line and a second line, wherein at least one of the first line and the second line is further coupled to a drive for operating the load, wherein the drive is configured for operation in at least one of inverter power and line power; and
a circuit coupled to the drive, wherein the circuit is configured for automatic or manual bypass operation of the drive;
wherein in an operable state, the circuit is configured to bypass operation of the drive when the drive experiences failure, wherein the circuit provides power to the load instead of the drive, and
wherein in a disabled state, the circuit is configured for normal operation of the drive when the drive does not experience failure, wherein the drive continues to operate the load.

2. The HVAC system of claim 1, wherein the circuit further comprises a contactor.

3. The HVAC system of claim 2, wherein the circuit further comprises:
a plurality of fuse disconnects, a relay, a capacitor, and at least one of a switch for automatic bypass and manual override connection points for manual bypass.

4. The HVAC system of claim 3, wherein the contactor includes inputs and outputs.

5. The HVAC system of claim 4, wherein inputs of the contactor are coupled to the first line and the second line of the voltage source, and outputs of the contactor are coupled to a main winding and a start winding of the motor.

6. The HVAC system of claim 5, wherein one of the inputs and outputs of the contactor is coupled to the capacitor.

7. The HVAC system of claim 6, wherein the relay is coupled to an inverter leg of the drive, the start winding of the motor, and the capacitor.

8. The HVAC system of claim 3, where a command to the switch for automatic bypass is provided by at least one of a standalone electronic circuit, from a system controller, and from a thermostat.

9. A heating ventilation and air conditioning (HVAC) system, comprising:
a motor for powering a load;
a voltage source having a first line and a second line, wherein at least one of the first line and the second line is further coupled to a drive for operating the load; and
a circuit coupled to the drive, wherein the circuit is configured for automatic or manual bypass operation of the drive,
wherein in an operable state, the circuit is configured to bypass operation of the drive when the drive experiences failure, wherein the circuit provides power to the load instead of the drive, and
wherein a disabled state, the circuit is configured for normal operation of the drive when the drive does not experience failure, wherein the drive continues to operate the load.

10. The HVAC system of claim 9, wherein the circuit further comprises a contactor.

11. The HVAC system of claim 10, wherein the contactor includes inputs and outputs.

12. The HVAC system of claim 11, wherein inputs of the contactor are coupled to the first line and the second line of the voltage source, outputs of the contactor are coupled to a main winding and a start winding of the motor.

13. The HVAC system of claim 9, wherein at least one inverter leg of the drive is coupled to a capacitor.

14. A bypass kit comprising:
a contactor having inputs and outputs for coupling with a drive, the contactor including inputs and outputs, wherein the inputs are configured for coupling to a voltage source having a first line and a second line, and the outputs are configured for coupling to at least one inverter leg of the drive,
wherein an operable state, operation of the drive is bypassed when the drive experiences failure, and a circuit configured for automatic or manual bypass coupled with the contactor provides power to a motor for powering a load instead of the drive, and
wherein a disabled state, operation of the drive is normal when the drive does not experience failure, and the drive continues to operate the motor for powering a load.

15. The bypass kit of claim 14, wherein one of the inputs and outputs of the contactor is coupled to a capacitor.

16. The bypass kit of claim 15, wherein outputs of the contactor are coupled to a main winding and a start winding of the motor.

17. The bypass kit of claim 16, wherein the circuit further comprises:
a switch for automatic bypass and manual override connection points for manual bypass.

18. The bypass kit of claim 17, further comprising a relay coupled to an inverter leg of the drive.

19. The bypass kit of claim 18, wherein the relay is coupled to the capacitor.

20. The bypass kit of claim 19, wherein the capacitor is coupled to the start winding and one of the outputs of the contactor.
